(19) United States
(12) Patent Application Publication
(10) Pub. No.: US 2005/0001150 A1
(43) Pub. Date: Jan. 6, 2005

(54) Light-receiving circuit that protects breakdown of the avalanche photodiode by the photo current generated thereby

(76) Inventor: Ryugen Yonemura, Kanagawa (JP)

Correspondence Address: MCDERMOTT WILL & EMERY LLP, 600 13TH STREET, N.W., WASHINGTON, DC, 20005-3096, US

(21) Appl. No.: 10/840,432

(22) Filed: May 7, 2004

(30) Foreign Application Priority Data
May 7, 2003 (JP) 2003-128672

(51) Int. Cl. H01J 40/14

(52) U.S. Cl. 250/214 R

(57) ABSTRACT

The present invention provides a light-receiving circuit that protects the breakdown of the avalanche photodiode (APD) by the photo current. The light-receiving circuit of the present invention includes the current detection circuit that senses the photo current generated by the APD, and, when the photo current exceeds a predetermined threshold, the current detection circuit turns on voltage dropping circuit for the high-voltage source. Accordingly, the bias voltage V_{APD} applied to the APD is decreased to the value at which the APD does not show a show the carrier multiplication.

### BACKGROUND OF THE INVENTION

1. Field of the Invention

The present invention relates to a light-receiving circuit, especially, the light-receiving circuit that provides an avalanche photodiode (APD) used, which is used in an analogue cable television system and a digital optical communication system.

2. Related Prior Art

In the optical communication system, especially in the system for a long span over 40 km, a light-receiving circuit including the APD is widely used, in which an amplifier having an automatic gain control function (AGC) is connected in serial to the APD and the output of the AGC amplifier is fed back to the AGC amplifier. The conventional circuit above mentioned forms an output with constant magnitude independent of the optical input power.

FIG. 8 is a block diagram of the conventional light-receiving circuit and FIG. 9 shows a relation of the optical input power to a carrier multiplication factor, the M-factor, and a gain of the AGC amplifier. The light-receiving circuit shown in FIG. 8 can decide whether the optical input exists or not. The circuit shown in FIG. 8 includes a comparator 61, a voltage-controlling circuit 62, a gain detection circuit 63, an APD 64, a sensing resistor 65, an AND gate 66, an AGC amplifier 67, a peak detection circuit 68, and a signal breaking circuit 69. While in FIG. 9, P₁ and P₂ shows a range in which the APD forms an output with constant magnitude, and un-degraded bandwidth and distortion. That is, P₁ corresponds to the minimum input power, P₂ corresponds to the maximum, and P₃ denotes the absolute maximum of the optical input power.

The APD 64 receives the optical input and converts the optical signal to the corresponding electrical current signal. The AGC amplifier 67 amplifies the electrical current signal generated by the APD 64, the peak detection circuit 68 detects the peak value of the output of the AGC amplifier 67, the voltage-controlling circuit 62 feedback the peak detection circuit to the APD 64 and the AGC amplifier such that the output of the APD keeps constant, and the signal breaking circuit 69 breaks the output of the light-receiving circuit when the output of the APD is broken.

When no optical input or the input power thereof below P₂ in FIG. 9, the gain of the AGC amplifier is set to be the maximum, which is constant to the optical input power. In this case, the voltage controlling circuit 62 controls the bias voltage to the APD 64 to decrease as the photo current increases, whereby the M-factor decreases as the optical input power increases. When the optical input exceeds P₂, the bias voltage is kept constant while the gain of the AGC amplifier is varied as the input power increase. Further, the optical input power exceeds P₃, both the bias voltage and the gain are kept constant. Simultaneously, when the photo current detected by the sensing resistor exceeds the predetermined threshold, the comparator 61 turns on and the breaks the signal breaking circuit 69.

In the conventional light-receiving circuit shown in FIG. 8, since the output of the APD 64 is fed back to the voltage controlling circuit 62 through the AGC amplifier 67, some delay may occur. Especially in the case that the optical input power is low, which is equivalent to the case that the gain of the AGC amplifier is large, the bandwidth of the feedback loop may not follow the change of the optical input power. On the other hand, in the case that the optical input power is large, since the M-factor is kept constant, which is equivalent to the constant bias voltage, the self-breakdown of the APD 64 may occur.

FIG. 10 is a block diagram for another light-receiving circuit, which solves the insufficient bandwidth of the closed loop mentioned above, and FIG. 11 shows the behavior of the M-factor and the gain of the AGC amplifier to the optical input power.

According to FIG. 11, the amplifier 75 keeps the M-factor constant below the input level P₁. The M-factor is controlled by the voltage controlling circuit 72 between the optical input power P₁ and P₂, while the gain of the AGC amplifier is kept constant. In this range of the optical input power, the bandwidth and the distortion characteristic of the APD are maintained. Further, between P₂ and P₃, the M-factor is kept constant by the voltage controlling circuit 72 and the output of the light-receiving circuit is maintained at a predetermined level by varying the gain of the AGC amplifier 77. Lastly, over the maximum input power P₃, the protection circuit 76 decreases the bias voltage to protect the APD 74 from breakdown by the photo current generated by the APD itself.

FIG. 12 shows a practical behavior of the M-factor for the APD used in the light-receiving circuit shown in FIG. 10. Optical input levels P₁, P₂, and P₃ in FIG. 12 correspond to those shown in FIG. 11. In FIG. 12, when the optical input power below −21.5 dBm (P₁), the protection circuit 76 operates such that the M-factor of the APD is kept constant, which is equivalent to the constant bias voltage to prevent the breakdown due to the large reverse bias voltage. In the range that the optical input power is from −21.5 dBm to −15 dBm (P₁−P₂), the M-factor varies from 3 to 9 to keep the output of the APD constant. In this range, the varying bias voltage does not influence the bandwidth and the distortion of the APD. Moreover, in the range from −15 dBm to −3 dBm (P₂−P₃), the output of the circuit is kept constant with un-degraded bandwidth and the distortion characteristic by the constant M-factor and the varying gain of the AGC amplifier 75. Further in the range over −3 dBm (P₃), the protection circuit 76 decreases the M-factor such that the APD may break by the excess photo current.

However, the light-receiving circuit shown in FIG. 8 can not completely prevent the APD from the self-breakdown in spite of providing the signal breaking circuit when no optical input signal is detected.

Moreover, the light-receiving circuit shown in FIG. 10, when the optical input power exceeds the threshold P₃, the protection circuit operates to decrease the M-factor. However, the M-factor still remains in a significant magnitude as shown in FIG. 12, whereby the self-breakdown of the APD may occur.

Further, the light-receiving circuit shown in FIG. 11, since the high-voltage source outputs the constant value, the current feedback resistor of 100 kΩ, for example, is inserted between the APD and the high-voltage source to automatically decrease the bias voltage. However, the power consumption due to the resistor amounts to 0.4 W when the optical input power and the photo current become 0 dBm and at least 2 mA, respectively, which prevents the small-sized light-receiving circuit.

Thus, one object of the present invention is to provide a light-receiving circuit using an avalanche photodiode protected from the breakdown even when a high optical input is received thereby and reducing a power consumption thereof.

### SUMMARY OF THE INVENTION

According to one aspect of the present invention, a light-receiving circuit provides an avalanche photodiode (APD), a voltage source, a current detection circuit and voltage dropping circuit. The APD generates a photo current by receiving an optical signal and has a carrier multiplication factor under a supplied bias voltage. The voltage source supplies the bias voltage to the APD. The current detection circuit detects the photo current generated by the APD. The voltage dropping circuit drops the bias voltage to a value the APD does not show the carrier multiplication when the photo current detected by the current detection circuit exceeds a predetermined level.

Since the bias voltage is dropped to the value the APD does not show the carrier multiplication at the input optical power over the predetermined level, the APD may be protected from the breakdown by the photo current generated by the APD itself.

The voltage source may be a DC to DC converter having a DC input and a DC output. The voltage dropping circuit drops the DC output when the photo current detected by the current detection circuit exceeds the predetermined level. The voltage dropping circuit may include first and second resistors, and a transistor. The first and second resistors are connected in serial to each other, and the transistor is connected in parallel to the first resistor. The first and second resistors, and the transistor are directed to the DC output of the voltage source. The DC output may be dropped in its voltage level by turning on the transistor and the first resistor being short-circuited thereby.

The current detection circuit may include a sensing resistor and a comparator. The sensing resistor flows the photo current generated by the APD, and the comparator detects the voltage drop induced by the sensing resistor and the photo current. When the voltage drop exceeds a predetermined value, which corresponds to the predetermined level of the photo current, the comparator turns on the transistor of the voltage drop circuit, whereby the DC output of the voltage source drops.

The current detection circuit may include a current mirror circuit. The APD may be coupled to the first current path, while the sensing resistor may be coupled to the second current path of the current mirror circuit, respectively.

### BRIEF DESCRIPTION OF DRAWINGS

FIG. 1 is a block diagram of an embodiment according to the present invention;

FIG. 2 shows an example of a relation of the multiplication factor, the M-factor, to the bias voltage;

FIG. 3 is a circuit diagram shaping the block diagram shown in FIG. 1;

FIG. 4 shows a behavior of the multiplication factor to the optical input power;

FIG. 5 shows another circuit diagram shaping the block diagram shown in FIG. 1;

FIG. 6 is still another circuit diagram shaping the block diagram shown in FIG. 1;

FIG. 7 is another circuit diagram shaping the block diagram shown in FIG. 1;

FIG. 8 is an exemplary block diagram of a conventional light-receiving circuit;

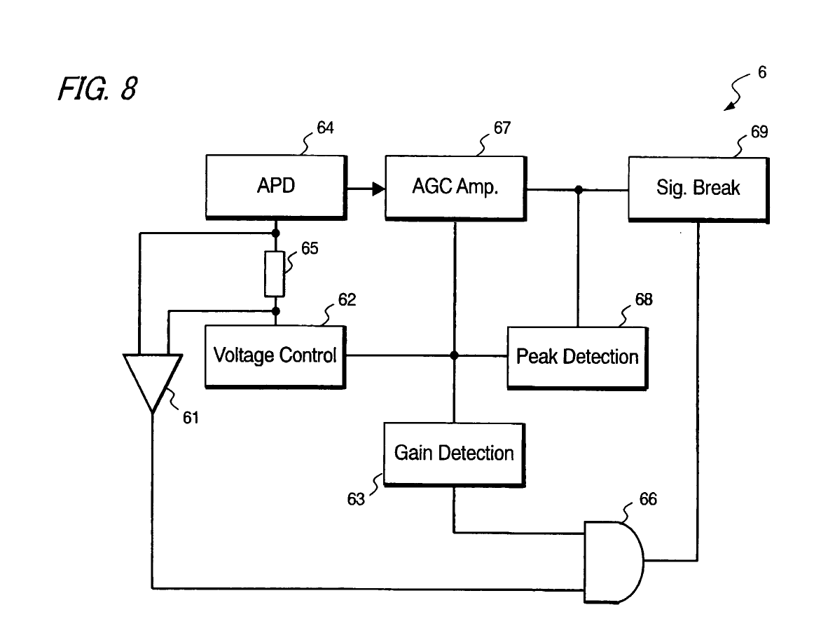

FIG. 9 shows a relation of the multiplication factor and the gain of the auto-gain-controlled amplifier to the optical input power of the conventional light-receiving circuit shown in FIG. 8;

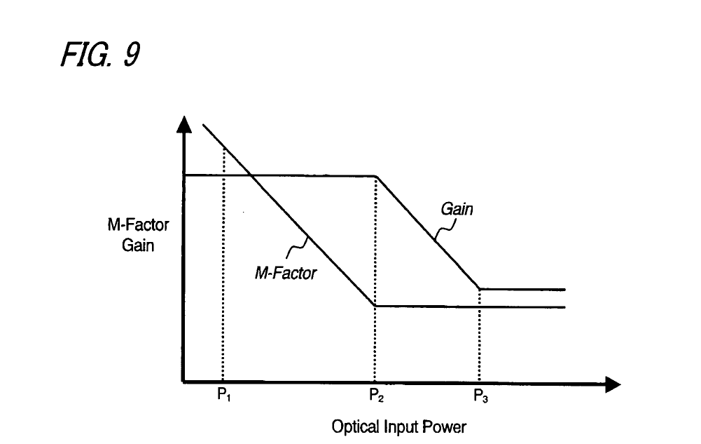

FIG. 10 is a block diagram of another conventional light-receiving circuit;

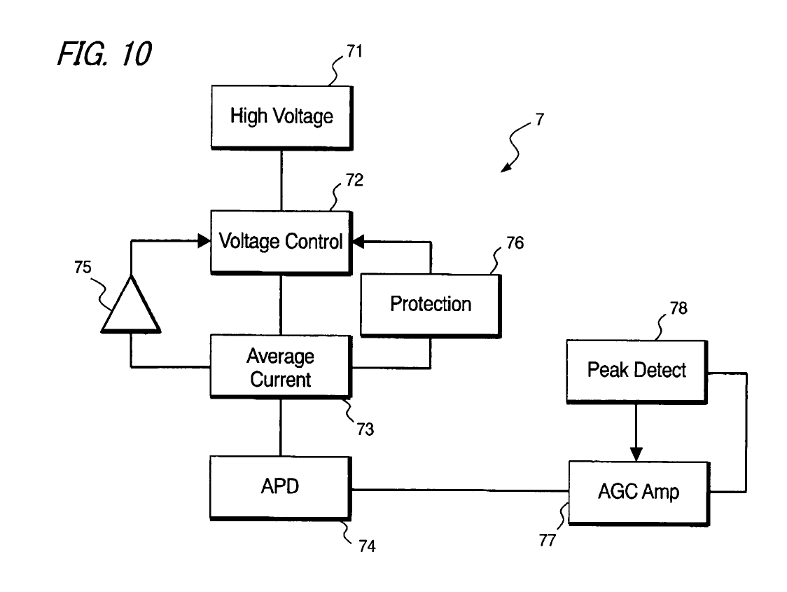

FIG. 11 shows a relation of the multiplication factor and the gain of the auto-gain-controlled amplifier shown in FIG. 10; and

FIG. 12 shows an experimental result of the multiplication factor to the optical input power of the light-receiving circuit shown in FIG. 10.

### DETAILED DESCRIPTION OF PREFERRED EMBODIMENTS

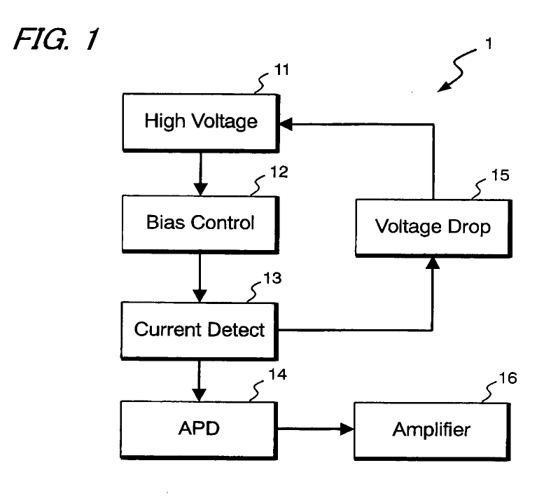

FIG. 1 is a block diagram showing an preferred embodiments according to the present invention. In FIG. 1, the light-receiving circuit 1 includes a high-voltage source 11, a bias controlling circuit 12, a current detector 13, an avalanche photodiode (APD) 14 and a voltage-dropping circuit 15. The light-receiving circuit 1 provides an amplifier 16 that amplifies an output of the APD 14 to constant amplitude.

The APD 14 is a semiconductor device that converts an optical signal into a corresponding electrical signal. The high-voltage source 11 generates a bias voltage supplied to the APD 14 under the control of the voltage-dropping circuit 15.

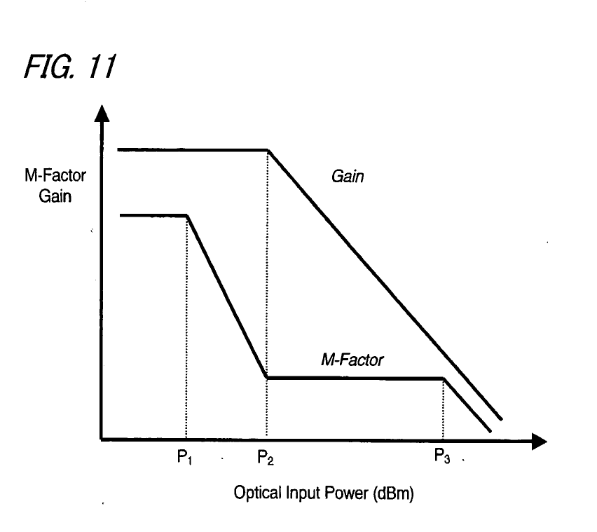

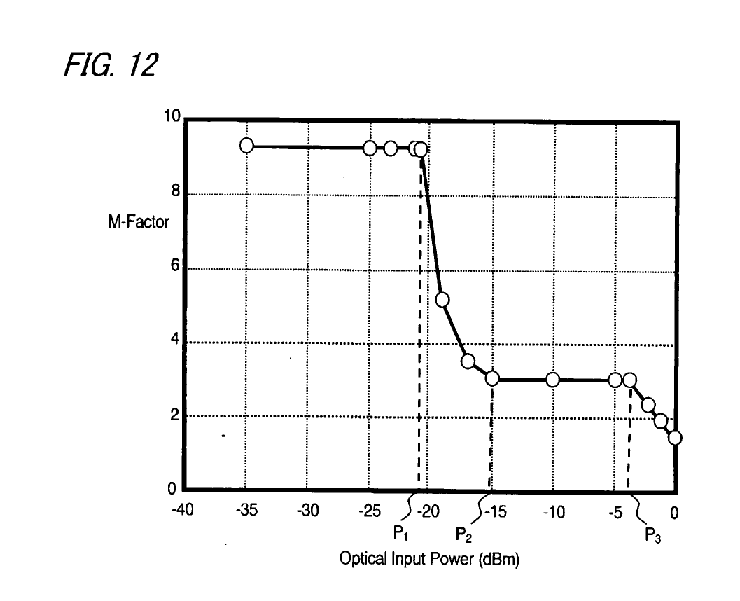

The bias controlling circuit 12 controls the bias voltage, which is generated by the high-voltage source, within which the APD shows an appropriate gain, which is called as the M-factor of the APD. Referring to FIG. 11 and FIG. 12, the M-factor of the APD is kept constant in the case that the optical input level is below P₁, and the M-factor is such controlled, when the optical input level is between P₁ and P₂, that the current generated at the APD is kept constant. Moreover, in the region over P₂, it may by applicable that the gain of the amplifier 16 connected to the APD is adjusted under the constant M-factor. In this case, the gain of the amplifier 16 is decided based on the current generated by the APD and detected by the current detection circuit 13 or another circuit that detects the average of the current generated thereby.

The amplifier 16 may provides an output-controlling circuit, which is not shown in FIG. 1. The amplifier 16 amplifies the current signal output from the APD 14 and converts it into a voltage signal. The output controlling circuit may have a function to control the gain of the amplifier 16 based on the current generated by the APD 14 such that the output of the light-receiving circuit 1 maintains constant.

The current detection circuit 13 detects the current generated by the APD 14 that may detect a peak value or an average thereof. The voltage-dropping circuit 15 decreases the output of the high-voltage source 11, based on the current detected by the current detection circuit 13, to a value the APD 14 shows the M-factor below 1, when the optical input level exceeds the maximum level. In other words, the bias voltage to the APD 14 may be shut down in the range the current generated by the APD exceeds a predetermined magnitude.

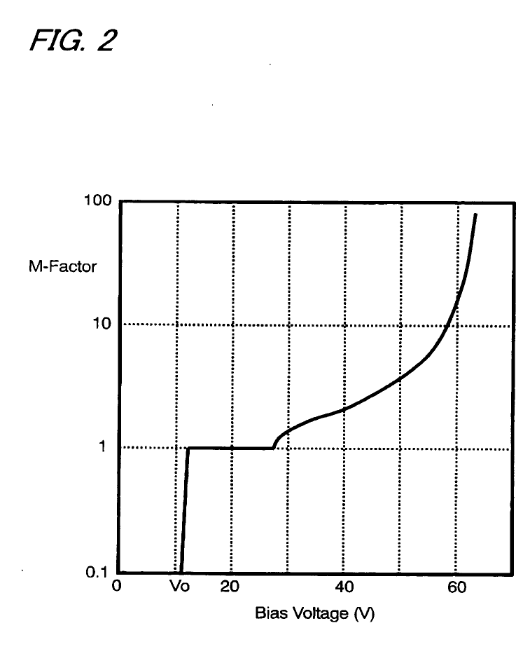

FIG. 2 shows a relation between the bias voltage and the M-factor of the APD. The APD in the present embodiment generates nearly no photo current when the bias voltage V_{APD} thereto below 11 V, which is denoted as V₀. Further, in a wide range of the bias voltage V_{APD} between 11 V and 27 V, the M-factor of the APD becomes unity. The conventional light-receiving circuit for the APD needs a resistor connected in serial to the APD for decreasing the bias voltage applied thereto. However, such conventional method should be avoided in the point that the M-factor of the APD is left significant value when the optical input level exceeds the maximum level. The APD may be broken by the current generated by itself. Accordingly, the M-factor must be decreased below unity in the range over the maximum input level, which is P₃ in FIG. 11 and FIG. 12.

The APD 14 biased below the critical voltage V₀ in FIG. 2 has the M-factor below unity, which is equivalent not to multiply the photo-carrier, accordingly no photo current is generated in the region over P₃ in FIG. 11 and FIG. 12. This not only saves the power consumption but also protects the breakdown of the APD 14 and the amplifier 16 connected to the APD 14, which simplifies the protection circuit for the APD 14.

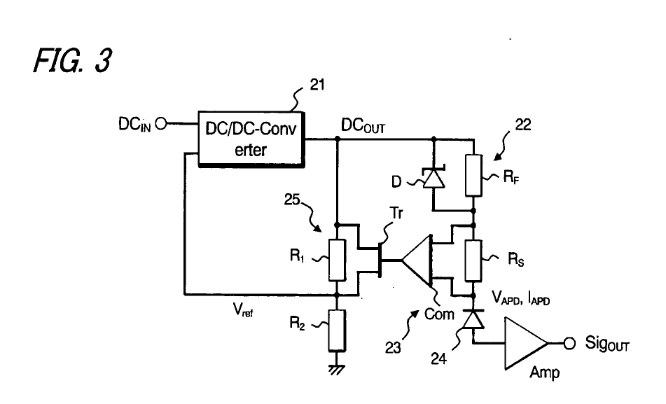

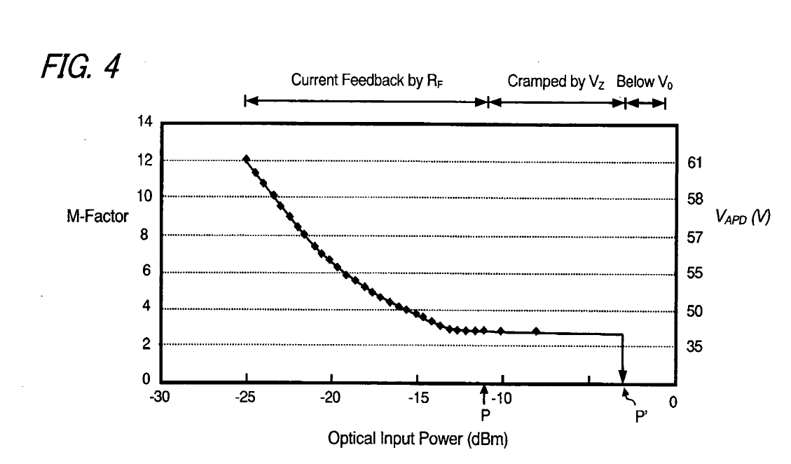

FIG. 3 is an exemplary circuit based on the block diagram shown in FIG. 1 and FIG. 4 shows the relation of the optical input level to the M-factor. In FIG. 3, the high-voltage source 11 in FIG. 1 is denoted as a DC/DC converter 21 that receives a DC voltage DC_{IN} to one of inputs thereof and outputs a corresponding DC voltage DC_{OUT} which is directed to the APD 24 through the bias controlling circuit 22 and the current detection circuit 23. Another input of the DC/DC converter 21 receives the DC_{OUT} divided by two resistors R₁ and R₂. The bias controlling circuit 22 includes a resistor R_{F} and a zener diode connected in parallel to the resistor R_{F}. The bias controlling circuit decreases the high voltage DC_{OUT} and output the reduced voltage to the APD 24. The current detection circuit includes a resistor R_{S}, the voltage drop thereby is detected by the comparator COM. The output of the comparator COM is directed to the transistor Tr connected in parallel to the resistor R₁. Two resistors R₁ and R₂, and the transistor Tr constitute the voltage dropping circuit 15 in FIG. 1. The amplifier AMP corresponds to the amplifier 16 in FIG. 1.

Next, the operation of the circuit in FIG. 3 will be described. When no optical signal inputs to the APD 24, no photo current is generated. When the optical signal with an input level below P in FIG. 4 is received, the resistor R_{F} connected in serial to the APD shows a current feedback function which decreased the bias voltage applied to the APD as the photo current generated thereby increases. That is, when the photo current is generated by the APD, the voltage drop by this current at the resistor R_{F} increases, which decreases the bias voltage applied to the APD 24 and simultaneously decreases the M-factor thereof.

The bias control circuit 22 also includes a zener diode D with a zener voltage V_{Z} in parallel to the resistor R_{F}. Although the APD 24 generates a relatively large photo current, the current feedback function described above decreases the bias voltage V_{APD} thereto, too small bias voltage V_{APD} results on the excess decrease of the M-factor. In the range when the current I_{APD} by the APD 24 multiplied by the resistor R_{F} is greater than the zener voltage V_{Z}, namely I_{APD}×R_{F}=V_{Z}, the voltage drop between the resistance R_{P} by the current I_{APD} will be cramped by the zener diode. Therefore, the bias voltage V_{APD} is not less than the value DC_{OUT}−V_{Z}. Accordingly, even under the great optical input, then maximum voltage drop at the bias controlling circuit 22 is limited to the zener voltage V_{Z}, and the substantial carrier multiplication, the M-factor, can be maintained in the APD 24.

However, when further great optical signal inputs the APD 24, since the M-factor is left by the significant value because the bias voltage applied thereto is cramped by the zener diode, accordingly, the further photo current is generated hereby and the APD may be broken by the photo current generated by the APD itself

In the present invention, another protection circuit having a device for monitoring the current generated in the APD 24 is provided in addition to the bias controlling circuit 22 having a cramping device. In FIG. 3, the sensing resistor R_{S} and the compartor COM are installed for sensing the current that exceeds the value to operate the zener diode. The resistor R_{S} and comparator COM corresponds to the current detection circuit 13 in FIG. 1 and denoted as the current detection circuit 23 in FIG. 3. The resistor R_{S} is connected between the APD 24 and the bias controlling circuit 22, and the comparator COM detects the voltage drop by the resistor R_{S}. In this embodiment, the current generated by the APD 24 is detected only by the resistor R_{S}, which simplifies the light-receiving circuit.

The voltage dropping circuit 23 forcibly drops the bias voltage V_{APD} of the APD 24 based on the current generated thereby, namely, in the light-receiving circuit shown in FIG. 3, the voltage dropping circuit 25 feeds the result of the current detection back to the reference voltage V_{REF} of the DC/DC converter 21.

When the current generated by the APD exceeds the threshold and the voltage drop (I_{APD}×R_{S}) at the sensing resistor R_{S} turns on the comparator COM, the output thereof also turns on the transistor Tr, and the resistor R1 is short circuited. Since the output DC_{OUT} of the DC/DC converter is denoted as follows;
DC_{OUT}=(1+R₁/R₂)×V_{REF},
the output DC_{OUT} of the DC/DC converter 21 becomes V_{REF} when the resistor R₁ is short circuited. In FIG. 3, although the reference voltage V_{REF} is based on the output DC_{OUT} of the DC/DC converter, it may be applicable that the reference voltage V_{REF} is independent from the output thereof.

In the present embodiment, since two resistors R_{F} and R_{S} are connected in serial to the APD 24, the ratio thereof should be considered because, when the resistance of the sensing resistor R_{S} is large, the sensing resistor R_{S} also operates as the current feedback resistor R_{F}. Therefore, the resistance of the sensing resistor should be far small compared to the current feed back resistor R_{F}. For example, when the current feed back resistor is 100 kΩ, the resistance of the sensing resistor R_{S} may be 1 kΩ, which is enough small not to operate as the current feed back resistor R_{F}.

The operation of the light-receiving circuit in FIG. 3 will be described as referring to FIG. 4 that shows a relation between the optical input power and the carrier multiplication factor, M-factor, of the APD. In the conventional circuit, even in the region when the optical input power exceeds a value P′, the M-factor of the APD is substantially left significant value. On the other hand in the present invention, the M-factor becomes substantially zero when the optical input power exceeds the value P′. When the optical input power is below P, the current feed back by the resistor R_{F} operates and the bias voltage V_{APD} is decreased by I_{APD}×R_{F}, which also decreases the M-factor. When the optical input power between P and P′, the zener diode D cramps the decrease of the bias voltage V_{APD} due to the resistor R_{F}. Moreover, when the optical input power exceeds P′, the protection circuit of the sensing resistor R_{S}, the comparator and the voltage dropping circuit operate, which forcibly drops the bias voltage V_{APD} to the value by which the carrier multiplication does not occur. The upper threshold P′ of the optical input power may be, for example, −3 dB.

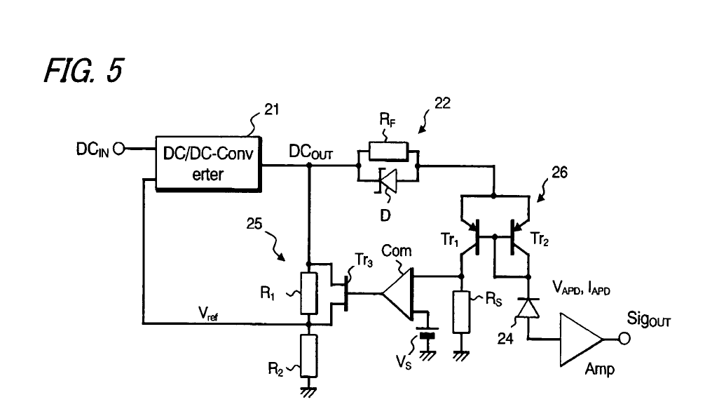

FIG. 5 shows an another embodiment of the present invention. The light-receiving circuit in FIG. 5, in addition to the circuit shown in FIG. 3, includes a current mirror circuit 26 and a standard voltage V_{S}. The circuit in FIG. 5 is different to the circuit in FIG. 3 in the point of the current detection. The comparator in FIG. 5 compares the voltage of the sensing resistor R_{S} to the standard voltage V_{S}, Further, the output of the comparator COM, similar to the circuit in FIG. 3, drives the transistor Tr₁ that short-circuit the resistor R₁.

The light-receiving circuit in FIG. 5 provides the current mirror circuit 26 for sensing the current generated by the APD 24. By using the current mirror circuit 26, not only the accuracy of the current sensing by the resistor R_{S} may be enhanced but also the threshold of the current sensing may be optionally selected and the circuit itself may be simplified.

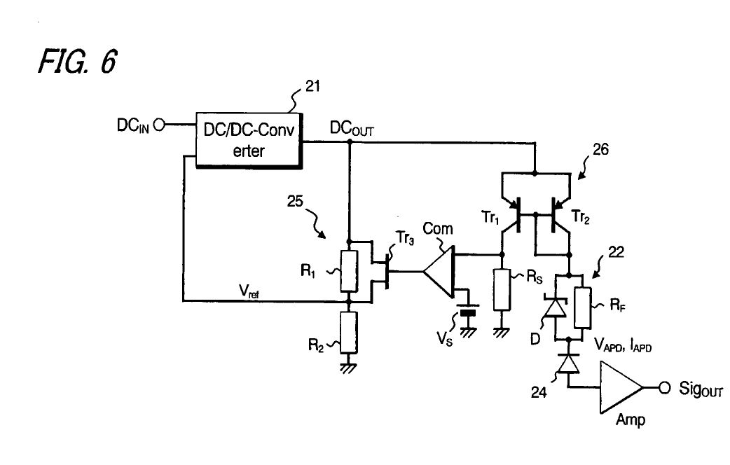

FIG. 6 shows still another embodiment of the present invention. The circuit shown in FIG. 6 provides the bias control circuit 22 between the current detection circuit 26 and the APD 24, namely the position of the current detection circuit 26 and the bias controlling circuit 22 is interchanged from the circuit shown in FIG. 5.

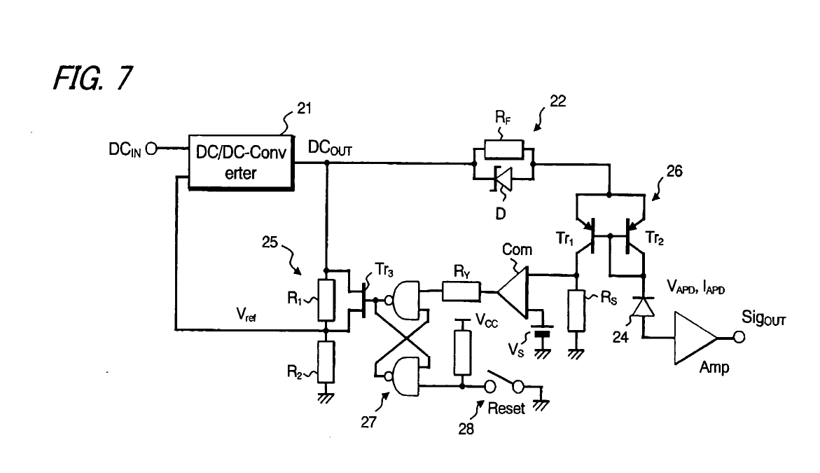

FIG. 7 shows another embodiment of the present invention, which further includes a holding circuit 27 and a reset switch 28. The light-receiving circuits shown in FIG. 3, FIG. 5, and FIG. 6 automatically recover from the protection mode. That is, when the optical input power exceeds the predetermined threshold, the voltage dropping circuit operates to drop the output DC_{OUT} of the DC/DC converter. However, once the bias voltage is dropped, the current generated by the APD is also decreased, which releases the protection mode and recovers the output DC_{OUT} of the DC/DC converter. Since the optical input power is left over the predetermined threshold, the light-receiving circuit enters in the protection mode again. Thus, the light-receiving circuit will repeat the protection mode and the normal operation mode.

Since the light-receiving circuit shown in FIG. 7 provides the holding circuit 27, which holds the protection mode, even when the bias voltage is dropped and the current generated by the APD 24 is also decreased, the voltage dropping circuit does not recover to the normal mode. After the optical input power becomes below the threshold, the holding circuit 27 is recovered by the reset switch 28, which makes the light-receiving circuit operate normally.

While embodiments and applications of this invention have been shown and described, it would be apparent to those skilled in the art that many more modifications than mentioned above are possible without departing from the inventive concepts herein.

1. A light-receiving circuit for receiving an optical signal and outputting an electrical signal corresponding to said optical signal, said light-receiving circuit comprising:
an avalanche photodiode for generating a photo current corresponding said optical signal, said avalanche photodiode having a carrier multiplication function by supplying a bias voltage;
a voltage source for supplying said bias voltage to said avalanche photodiode;
a current detection circuit for detecting said photo current generated by said avalanche photodiode; and
a voltage dropping circuit for dropping said bias voltage, when said photo current detected by said current detection circuit exceeds a predetermined level, to a value said avalanche photodiode does not show said carrier multiplication thereunder.

2. The light-receiving circuit according to claim 1, further comprises a bias controlling circuit between said voltage source and said avalanche photodiode, said bias controlling circuit including a current feedback resistor.

3. The light-receiving circuit according to claim 2, wherein said bias controlling circuit further includes a zener diode connected in parallel to said current feedback resistor.

4. The light-receiving circuit according to claim 2, wherein said bias controlling circuit is provided between said voltage source and said current detection circuit.

5. The light-receiving circuit according to claim 2, wherein said bias controlling circuit is provided between said current detection circuit and said avalanche photodiode.

6. The light-receiving circuit according to claim 1, wherein said voltage source includes a DC to DC converter having a DC input and a DC output, and said voltage dropping circuit, when said photo current detected by said current detection circuit exceeds said predetermined level, drops said DC output of said DC to DC converter.

7. The light-receiving circuit according to claim 6, wherein said voltage dropping circuit includes a first resistor, a second resistor connected in serial to said first resistor, and a transistor connected in parallel to said first resistor and in serial to said second resistor, said first and second resistors and said transistor being directed to said DC output of said voltage source, and
wherein said first resistor being short-circuited by turning on said transistor when said photo current detected by said current detection circuit exceeds said predetermined level, said DC output of said voltage source being dropped thereby.

8. The light-receiving circuit according to claim 6, wherein said current detection circuit includes a sensing resistor for flowing said photo current and a comparator for detecting a voltage generated by said resistor and said photo current, said compartor turning on said transistor of said voltage dropping circuit.

9. The light-receiving circuit according to claim 8, wherein said current detection circuit further includes a current mirror circuit having a first current path and a second current path, said avalanche photodiode being coupled to said first current path and said sensing resistor being coupled to said second current path.

10. The light-receiving circuit according to claim 1, further provides a holding circuit for holding a protection mode said light-receiving circuit entering therein when said photo current detected by said current detection circuit exceeds said predetermined level and drops said DC output of said DC to DC converter.

11. The light-receiving circuit according to claim 10, further provides a reset switch for releasing said protection mode and for entering said light-receiving circuit to a normal mode in which said avalanche photodiode is supplied said bias voltage from said DC to DC converter.
